(19) United States
(12) Patent Application Publication
(10) Pub. No.: US 2007/0065087 A1
(43) Pub. Date: Mar. 22, 2007

(54) Device and a method for integrated multi-channel mems variable optical attenuators

(76) Inventor: Claudio G Jacobson, Binyamina (IL)

Correspondence Address: EDWARD LANGER;c/o SHIBOLETH YISRAELI ROBERTS ZISMAN & CO., EMPIRE STATE BUILDING, 60TH FLOOR, 350 FIFTH AVENUE, NEW YORK, NY, 10118, US

(21) Appl. No.: 10/551,098

(22) PCT Filed: Mar. 29, 2004
(86) PCT No.: PCT/IL04/00283

§ 371 Date: Jul. 19, 2006

(30) Foreign Application Priority Data
Apr. 2, 2003 (IL) 155195

(51) Int. Cl. G02B 6/26

(52) U.S. Cl. 385/140; 385/19

(57) ABSTRACT

A single or multi-channel MEMS (Micro Electro Mechanical Systems) variable optical attenuator employing a novel construction method. An optical fiber (18) or waveguide is secured on a substrate (32), for example in a groove (36) formed in the substrate (32), and is then cut to an appropriate depth (by dicing, etching, laser cutting or any other means) for ensuring alignment between the two fiber segments (22, 24) thus obtained, thus eliminating prior art misalignment problems. After securing and cutting of the fiber (18), a MEMS shutter (26) is arranged for dynamically controlled positioning in the gap (28), to block any required amount of the power of an optical signal that propagates in the gap (28) between the optical fiber segments (22, 24). The amount of blocking is controlled using electrostatic actuation or by any other means, to provide the instantaneously required attenuation

### FIELD OF THE INVENTION

The present invention relates to optical micro electromechanical systems (MEMS) and devices, and more particularly, to an improved method and system for applying a MEMS device for the attenuation of light beams and signals in optical communications and optical signal processing applications, whenever it is necessary to attenuate independently one or several optical channels.

### BACKGROUND OF THE INVENTION

Optical waveguide attenuators are a broad family of devices that are used to attenuate optical signal power propagating in optical waveguides. An optical fiber is an important example of an optical waveguide. Its principal use is to confine light waves so that they travel within, and are guided by, the fiber.

In some cases, the goal of the attenuator is to reduce signal intensity, which might otherwise overload or saturate other components like amplifiers or receivers. In other cases, the goal is to balance the power of signals transmitted through the same system at different wavelengths and to obtain gain equalization. These optical devices are widely needed and used for enabling the performance of optical systems in general, and fiber-optic communication systems in particular.

There are several types of attenuators. The method used to achieve signal attenuation is either to absorb the extra light energy, to deflect it or to reflect it. Generally, it is desirable that the amount of attenuation should not depend significantly upon the wavelength or upon the polarization of the light. Therefore, mechanical attenuators, which physically block part of the power, usually have an advantage over attenuators that are based on electro-optical effects, since the latter type usually introduce more dependence on wavelength and polarization. Fixed attenuators reduce the input power by a fixed fraction while variable optical attenuators (VOAs) allow adjustment of the attenuation within a specified range. Electrically controlled VOAs are analog devices where the attenuation is adjusted arid controlled by electrical means.

Variable Optical Attenuators are used also to obtain gain-equalization. Fiber optic amplifiers do not amplify all wavelengths equally, because their gain varies with wavelength. By using variable attenuators to control optical power at different wavelength channels, gain-equalization can be obtained.

An optical fiber is constructed as a filament of dielectric material, usually circular in cross section, and manufactured of glass or plastic. In a typical optical fiber light is confined in a region of high refractive index, which is surrounded by a material having a smaller refractive index. The refractive index of a medium is the ratio of the velocity of propagation of an electromagnetic wave in vacuum to its velocity in the medium. An optical fiber usually has a cylindrical core. The core is typically surrounded by, and in intimate contact with, a cladding so that the core and the cladding together form a cylindrical structure.

The physical mechanism responsible for the waveguiding behaviour of such an optical fiber is Fresnel total internal reflection of light at the core/cladding interface. The total diameter of that cylinder is typically 50 to 125 μm, although other diameters exist as well. The cladding of the optical fiber is a layer of material of lower refractive index n₂, in intimate contact with the core material of higher refractive index ni, where n₁>n₂. A plastic coating, of typically 62.5 μm thickness, generally surrounds both the core and cladding. Thus, for example, in case the core and the cladding together have a diameter of 125 μm, the entire configuration comprises 250 μm in diameter. For many purposes the plastic coating is removed along certain sections of the fiber. A fiber without a coating is referred to as a bare fiber.

An optical fiber can operate either as a monomode waveguide or as a multimode waveguide, depending on the refractive index difference between core and cladding, the diameter of the core and the wavelength of the propagating light. This dependence on structural parameters is captured by the normalized frequency V of the fiber, which for a step index core fiber is given by the expression:
V=2πα(n₁²−n₂²)^{1/2}/λ

where the radius of the core is α and the wavelength of the light is λ both expressed in consistent units. A fiber is said to operate in the monomode regime whenever 0<V<2.405.

Other types of (unconventional) optical fibers have been demonstrated that do not use total internal reflection of the light at the core/cladding interface as the light-guiding mechanism. Examples of these unconventional fibers are the hollow-core fiber, the ARROW fiber and modified-core fibers (including multi-core fibers). The MEMS based attenuator, which is the subject of this invention, can also be used with such fibers.

Optical fibers are not the only type of optical waveguides. For example, planar waveguides are based on the same idea of confining light in a region of high refractive index by surrounding it in contact with a material having a smaller refractive index. However, a planar waveguide is flat in cross-section instead of cylindrical. The innovative concepts of the present invention are relevant to all types of waveguides, including unconventional waveguiding structures, and therefore, in the following text and drawings, reference to an optical fiber should be understood also to cover any other type of waveguide.

A VOA for fiber optic communication systems can be achieved by use of a mechanical shutter. Existing variable optical attenuators (VOA's), which use shutters, are designed around the structural concept of a movable mechanical shutter whose function it is to attenuate the light. Two fiber segments are placed and secured in a groove used to achieve optical alignment and optical connectivity between the segments. The segments are separated by a gap region (free propagation region) that is narrow enough to ensure good optical connectivity between the fiber segments but wide enough to allow insertion of the shutter in the gap between the fiber segments.

Movement of the shutter in the gap can block, or partially block, the optical path between the segments, thereby attenuating the light propagating from the upstream fiber segment to the downstream fiber segment. The position of the movable shutter in the gap (free propagation region) between the fiber segments determines the intensity of the optical power that is coupled to the receiving (output) fiber segment, after emerging from the input fiber segment.

The very existence of the gap introduces a measurable loss of optical power, which is referred to as “insertion loss”. This is mainly because some of the optical signal which exits from one segment is partially dispersed before continuing into the second fiber segment, even without the introduction of a shutter. It is essential to reduce the insertion loss because when no attenuation is needed, it is required to maintain the available power. Therefore, the optical alignment of the two fiber segments, to achieve low insertion loss and high optical coupling, wherever there is a gap or a discontinuity in the fibers, is a major issue. Thus, the insertion loss, representing the light-coupling efficiency between input and output fibers, depends on the alignment accuracy of the two segments of fibers in the gap, with respect to each other.

Another aspect of shutter design is that there be minimal back reflection (known as high “return loss”) from the shutter back into the first, upstream, segment of optical fiber. Therefore such shutters are usually manufactured in the form of mirrors set at a 45° angle or close to that angle, so as to direct reflected light perpendicularly to the path, i.e., off to one side and not directly back into the path emanating from the first segment. In order to avoid Fresnel back reflections at the two fiber-gap interfaces of the upstream and downstream fibers (input and output fibers), the fibers are cut at an angle (usually around 8°) to the lateral direction to the optical path. Index matching fluid in the gap between the two fibers is also used for minimizing insertion and maximizing return losses (see below).

With the advent of the relatively new technology based on MEMS (Micro Electro Mechanical Systems) or Optical MEMS (MOEMS), it has become attractive, in terms of new functionality as well as potential cost, to design VOAs based on MEMS concepts and micromachining technologies. The literature concerning MEMS applications and its significant technological and business potential is available in several textbooks. (See for example: N. Maluf, “An introduction to Micromechanical System Engineering”, Artech House, Boston, ISBN 0-89006-581-0, 2000; Marc J. Madou, “Fundamentals of Microfabrication—the Science of Miniaturization”, 2^{nd} edition, CRC Press, ISBN 0-8493-0826-7, 2002.) The most developed Micro-Opto-Electro-mechanical systems (MOEMS), may include sensors, mirrors, scanners, shutters and switches. They can be combined with microelectronics and micro-sensors to form an integrated on-chip or a hybrid-assembled system. These techniques can be used to build electrically controlled shutters that can be used to regulate the optical throughput in optical fibers.

Thus, the shutter and the shutter actuator of a VOA, can be achieved by MEMS micro-fabrication technologies, based on silicon processes like photolithography, etching, thin film deposition etc. These devices can be batch fabricated on large-area silicon substrates and represent the smallest available in a vast field of actuators. In many cases, an angled mirror is deposited on the shutter to reflect the attenuated power. The mirror is sometimes essential not only for maximizing return loss (see above), but also to avoid excessive heating of the shutter while the angle is needed to avoid back-reflectance of the light into the transmitting (input) fiber.

MEMS attenuators were studied and fabricated in several universities and companies. One prominent example is the University of Neuchatel in Switzerland (see for example Marxer C., et al., “Vertical Mirrors Fabricated by Deep Reactive Ion Etching for Fiber-Optic Switching Applications”, Journal of Micromechanical Systems, Vol.6, No. 3, September 1997, pp. 277-185; C. Marxer, PhD Dissertation, Faculty of Sciences of the University of Neuchatel, Switzerland, June 1997 and C. Marxer, P. Griss, N. F. de Rooij, “A variable optical attenuator based on silicon micromechanics”, IEEE Photonics Technology Letters, Vol.11(2), pp.233-235, 1999). A commercial company (Sercalo Microtechnology Ltd. Rue des Draizes 5, Neuchatel 2000, Switzerland) now commercially produces MOEMS. For more details a website is available at Cornel.marxer@sercalo.com.

The above describes prior-art techniques for making MEMS VOAs, using Deep Reactive Ion Etching (DRIE) and Silicon-On-Insulator (SOI) wafers. DRIE is a known technique, which allows structures to be lithographically defined on the surface of a silicon wafer, and etched into that wafer with near-vertical sidewalls. The resulting structures have relatively high-aspect ratio, that is, a ratio of etched depth to feature width of about 20:1. Suspension springs made with this technique tend to have high out-of-plane stiffness, combined with high in-plane compliance.

Similarly, electrostatic elements such as parallel plates and comb-drive structures (see texts books and literature above) have high capacitance per die area, providing suitable force for moving optical elements. However, the equipment for doing DRIE, namely a DRIE system, is expensive, the etching process is expensive and the SOI wafers are costly (approximately ten times the cost of ordinary silicon wafers). FIG.1 shows a prior art variable optical attenuator, activated by a mechanical shutter and a comb-drive actuator and fabricated in SOI, using DRIE.

The VOA device shown in FIG.1 (IEEE Photonics Technology Letters, vol. 11, No.2, February 1999) illustrates the basic structure of one possible prior-art implementation of a MEMS attenuator. It is fabricated using Silicon-on-Insulator (SOI) wafers and Deep Reactive Ion Etching (DRIE) etching. The basic structural design is in accordance to the concept described above: A mechanical movable shutter is built using an SOI wafer and DRIE process. The shutter is suspended on suspension springs (folded beam mechanism) and is actuated by a comb-drive electrostatic actuator that is actuated by externally applied voltage. The shutter, suspension springs, comb-drive actuator and the grooves to accommodate the two fiber segments, are all fabricated in the same DRIE process. The exact position of the shutter between the two fiber segments, and hence the amount of light attenuation, is determined as an equilibrium position in which the mechanical force exerted on the shutter by the suspension springs is equal to the electrostatic force that builds up in the electrostatic comb-drive actuator, due to the externally applied voltage. The fiber segments (not shown in FIG.1) are secured in the grooves after the etching process is finished.

During the placement and securing of the optical fibers, much care has to be taken so as to minimize the insertion loss. The fibers need to be inserted in the grooves and aligned after completing the DRIE process. The two fiber segments generally have cores that have some off-the-center mismatch within their respective claddings. Moreover, there are variations (˜1%) in the diameter of the fiber cladding. Therefore, even with ideal etched grooves to accommodate the two fiber segments, obtaining high optical coupling (low insertion loss) is tedious and not easy. The whole process of optical packaging therefore becomes time consuming and costly.

A description of the coupling losses between two fibers coupled by a MEMS mirror can be found in patent WO 01/57578“Mehrfachschalter”. An example of a MEMS VOA based on diffraction effects is described in U.S. Pat. No. 5,508,840, “light modulator”.

Thus, as the capabilities, usage and applications increase for MEMS variable optical attenuators, there is a need for MEMS variable optical attenuators that overcome the disadvantages of the prior art, which are discussed above, as well as below.

### SUMMARY OF THE INVENTION

Accordingly, it is a principal object of the present invention to overcome the disadvantages of prior art systems, and to provide a method and a system to enable attenuation of an optical signal in an optical fiber system with improved performance as well as manufacturability and hence price.

It is another object of the present invention to provide a method and a system to minimize the optical misalignment and thus insertion loss introduced between segments of an optical fiber when a gap is introduced between them.

It is yet another object of the present invention to provide a method and a system to provide integrated monitoring of the output power measured after traversing an optical attenuator, for the purpose of integrated feedback control of the attenuation, as well as for any other purposes.

It is a further object of the present invention to provide a method and a system for manufacturing VOAs, using standard silicon wafers instead of the expensive silicon-on-insulator (SOI) wafers, and lower-cost micromachining technology, such as wet anisotropic etching, instead of expensive Deep Reactive Ion Etching (DRIE) technology.

In accordance with a preferred embodiment of the present invention, there is provided a MEMS variable optical attenuator device, comprising:
a substrate having formed therein means for securing at least one optical waveguide;
at least one optical waveguide, each having a gap between segments thereof, wherein said gap is formed once said at least one optical waveguide is secured by said securing means, thereby to insure optical alignment between said optical waveguide segments;
shutter means mounted proximate said gap formed in said at least one optical waveguide, said shutter means being movable inside said gap, in a dynamically variable amount as required, so as to block controllably a portion of the power of an optical signal propagating in said gap, between said optical waveguide segments; and
shutter actuation means to move said shutter means controllably and dynamically to any required position within said gap.

In a preferred embodiment, the inventive MEMS variable attenuator is provided as an N-Channel-IN M-Channel-OUT Optical Channel Array Variable Attenuator (N-M-OCAVA). The inventive N-M-OCAVA device is a general conceptual device that can take many forms, and is useful in optical communications and optical signal processing applications where it is desirable to attenuate independently several optical channels.

The topology of the inventive device consists of a first optical interconnection means between optical waveguides of the N-by-M optical channel array of the variable attenuator. The device is also designed to accommodate a second means to attenuate optical signal beams. An optical signal beam propagates from a first upstream channel in the N-by-M array to a second downstream channel in the array through the first optical interconnection means. The optical signal beam can encounter the attenuation means either upstream or downstream from the interconnection means.

The N-Channel-IN M-Channel-OUT Optical Channel Array Variable Attenuator comprises means to support and configure in space N input optical channels and M output optical channels. The N input and M output channels are optically connected in a manner consistent with the desired integrated functionality of the device. Thus, the topology of the device can be quite general. The optical channels take relative positions with respect to one another, and these positions are determined by the chosen geometry of the supporting means. This topology is determined as well by the nature and geometry of the chosen optical interconnection means that is included for linking the N-by-M arrayed channels. The geometrical form of the supporting means and the disposition of the optical channels on, or within, the supporting means is predetermined and chosen to be a beneficial configuration in keeping with the desired functionality of the device. The number of input channels, N, and the number of output channels, M, are, respectively, the number of input and output optical signals that the N-M-OCAVA is designed to handle.

The platform that provides the means to support and configure the optical N-by-M optical channels is designed to ensure that the channels in either the N channel group, or the M channel group, are parallel to all the neighboring channels of the same channel group, in a region of space defined on, or in, the support and configuration platform. When it is advantageous to do so, these regions of parallelism can be included, by design, for both of the groups in the device. The dimensions of the region(s) of parallelism are chosen to enable their use as regions suitable for the introduction of free-propagation regions in the device, as explained below. Suitable free-propagation regions can be either an integral part of the topology of the optical channels or they can be fabricated at an appropriate point in the manufacturing cycle within a region of parallelism. The important point to understand is that the free-propagation regions are essential to the functionality of the N-M-OCAVA.

The purpose of providing for spatial regions of optical channel parallelism within at least one of the two (input or output) channel groups is to permit the creation of free-propagation regions within each channel group. A free-propagation region can be thought of as a low-loss optical-channel discontinuity.

The free-propagation regions are used to facilitate the integration within the device of means to attenuate the optical signals either in the N input or M output channels, or both. Generally, the free-propagation regions need not be intrinsic to the specific optical channel geometry used in the device. When free-propagation regions are not an intrinsic property of the optical channel type chosen to implement the N-M-OCAVA, they must be introduced into the device in a convenient and economic manner. One of the innovations of the present invention is the provision of means to introduce free-propagation regions suitable for use in the N-M-OCAVA.

Therefore, in accordance with the method of the present invention, the capability of the N-M-OCAVA to attenuate optical signals is provided by the introduction of suitable attenuation means into the free propagation region located in each input or output channel of the device. The free-propagation regions can be intrinsic to the type of optical channel used in the construction of the N-M-OCAVA or they can be introduced in an appropriate manner consistent with the functionality of the device.

In a preferred embodiment of the present invention, the optical input and output channels of the device take the form of mono-mode optical waveguides. It will be appreciated that other means can also be used to implement optical channels that fall within the scope of the present invention. The waveguides are usually optical fibers or integrated-optics waveguides (for example, glass-, optical crystal- or semiconductor-based) and can include regions of free-space propagation. Mixed waveguides fall within the scope of the invention. A mixed waveguide is implemented by providing a low-loss device for the optical interconnection of one optical waveguide type to another.

The free-space propagation region is implemented in such a manner that light carried by the upstream waveguide can propagate across the free-space propagation region and be efficiently optically coupled to the downstream waveguide. Such an interconnection device can include, for example, the serial/physical, interconnection between an optical fiber and an integrated optics waveguide, whether with, or without, an intermediate free propagation region. Such an interconnection means can also include a short, free-space propagation region located between one optical waveguide and another of the same type. The free-space propagation region can be filled with fluid having optical, fluidic and thermal properties appropriate to the functionality of the device.

In accordance with a preferred embodiment of the present invention, support for the optical waveguides normally will take the form of an essentially planar platform shaped and formed to accommodate the N-by-M optical waveguide array. The platform is further designed to accommodate the means which are intended to attenuate the optical signals.

When the channels take the form of optical waveguides supported and mounted on a planar platform, the free-propagation regions are not intrinsic to the waveguides and therefore usually must be manufactured. A convenient way to manufacture the free-propagation regions is to use an appropriate tool to make a straight line cut that traverses all the parallel optical channels in the group. The cut is oriented at a chosen angle with respect to the parallel longitudinal axes of the optical channels within the group. The angle is selected to achieve an optical return loss within design specifications. The depth of the cut is set to be sufficiently deep so that optically opaque or reflective material introduced in the free propagation region formed by the cut can block completely, for all intents and purposes, light propagating from the upstream to the downstream waveguide.

Based on this design, a suitable variable shutter introduced within the free-propagation region will be able to attenuate a signal over a wide dynamic range extending from low attenuation to high attenuation. At the same time, the depth of the cut is chosen to be sufficiently shallow so that the mechanical strength of the supporting platform is not reduced below the minimum acceptable value.

In a further delineation of a preferred embodiment implemented with optical fiber waveguides, the planar platform is provided with at least N V- or U-grooves (V and U grooves—are, respectively, grooves with a cross section like the letters V and U), or otherwise shaped grooves, within which are placed, mounted and secured the N optical fibers in N-M-OCAVA configuration.

Because the free-propagation regions are cut at an angle to the axis of the optical fiber waveguides, it is advantageous to introduce a refractive index fluid in the free-propagation region that serves to refractive-index-match the region to the effective index of the waveguides. The introduction of the fluid serves to minimize reflections at free-propagation-region/optical waveguide interfaces and minimizes prismatic beam bending which would otherwise have a detrimental effect on coupling loss across the free-propagation region.

This N-Channel-IN M-Channel-OUT Optical Channel Array Variable Attenuator can be configured using polarization maintaining optical fibers or integrated-optics waveguides. In this case it may be desirable to attenuate one principal state-of-polarization propagating in the waveguide preferentially over the other principal state-of-polarization. This is accomplished by using a polarization-dependent optical shutter for attenuation.

It is desirable for N-M-OCAVA control purposes to be able to monitor the optical signal level in each of the M output channels. In an optical waveguide-based device signal monitoring can be accomplished by leaking out a small amount of signal (˜1%) from each of output waveguides and then directing the leaked signal to photo detectors for measurement. The signal leaking function can be implemented by several means. One preferred means is to crimp the waveguide to create a radiation condition. Another preferred means is to introduce a Bragg grating tap in the waveguide core. Yet another preferred means is to introduce a strong refractive index perturbation in the core of the waveguide slanted at a blaze angle to the axis of the waveguide. The refractive index perturbation serves to tap out a small amount of signal and direct it to the monitoring photo detector.

Additional features and advantages of the invention will become apparent from the following drawings and description.

### BRIEF DESCRIPTION OF THE DRAWINGS

The features of the disclosed method and system will become more readily apparent, and may be better understood, by referring to the following detailed description of an illustrative embodiment of the present invention, taken in conjunction with the accompanying drawings, wherein:

FIG. 1 is an illustration of a prior art DRIE manufactured VOA showing a shutter, a comb-drive electrostatic actuator and an empty groove for securing two pre-cleaved optical fiber segments;

FIGS. 2a and 2b are schematic illustrations of a substrate with a groove (FIG.2a), and a section of a bare (without jacket) optical fiber, secured in the groove (FIG.2b);

FIG. 2c illustrates a gap, which is formed in the secured fiber by dicing or any other method, in accordance with the principles of the present invention;

FIG. 3a is a schematic illustration of a “base unit” for one-channel VOA, constructed and operated in accordance with the principles of the invention, featuring a secured bare optical fiber in which a gap has been formed as in FIG. 2c, to make input and output aligned fibers, out of one fiber section;

FIG. 3b illustrates a detail of FIG. 3a, describing one possibility of coupling a photo-detector to the output fiber segment, to enable sensing the optical power leaking from a certain region in the output fiber, which is in contact with the photo-detector;

FIG. 4a is a schematic illustration of a “cantilever-shutter” unit for one-channel VOA, constructed and operated in accordance with the principles of the invention, featuring a frame and a flexible cantilever, which is hinged at one end to the frame and is formed with a shutter;

FIG. 4b is a schematic illustration of a “cantilever-shutter” unit designed like the unit of FIG. 4a, with the addition of holes in the flexible cantilever to reduce the drag force induced by the index matching fluid;

FIG. 4c is a schematic illustration of a detail of FIG. 4b, showing the shutter and holes in the flexible cantilever in an enlarged scale;

FIG. 4d illustrates the same “cantilever-shutter” unit as in FIG. 4b but looking from another direction, for better clarity;

FIG. 4e is a schematic illustration of a “cantilever-shutter” unit, formed with an opening in the frame, to enable easier filling with index matching fluid;

FIG. 5 illustrates an “electrode unit” for a one-channel VOA, constructed and operated in accordance with the principles of the present invention, featuring an electrode for electrostatic activation of the flexible cantilever;

FIG. 6a illustrates the shutter arranged to completely block the entire free space path of the light between the input and output fibers;

FIG. 6b illustrates the shutter in a position for only partial blocking;

FIG. 7 illustrates a pyramid-shaped shutter, arranged in a featured gap, which has been tailored to the geometry of the shutter and designed to minimize the width of the gap between the cores of the optical fiber segments, in order to minimize insertion-loss;

FIG. 8 illustrates a base unit, which contains several fibers for a multi-channel VOA (shown here for 4 fibers), with each of the fibers fixed in its own groove and all of them oriented in parallel, also showing a cut that runs through all the fibers to create the gaps, in accordance with the principles of the invention;

FIG. 9 illustrates a “cantilever-shutter” unit for multi-channel VOA, with several shutters (shown here 4), each mounted on Rs own flexible cantilever;

FIG. 10 illustrates an electrode unit for multi-channel VOA, which contains several electrodes corresponding to the number of flexible cantilevers (shown here for 4);

FIG. 11a illustrates the first step of vertical integration of a multi-channel VOA (shown here for 4 channels);

FIG. 11b illustrates the second step, completing the vertical integration of a multi-channel VOA (shown here for 4 channels), in which the three units (base unit, cantilever-shutter unit and electrode unit) are all integrated vertically; and

FIG. 12 illustrates the integration of the multi-channel VOA (shown here for 8 channels), where stacking vertically two units, each with four channels, increases the number of channels.

### DETAILED DESCRIPTION OF A PREFERRED EMBODIMENT

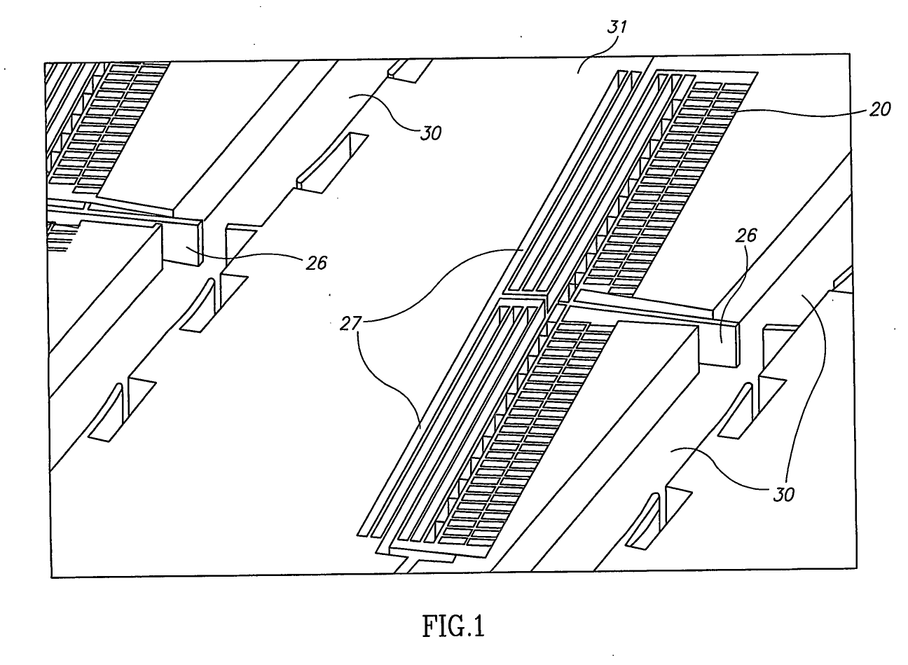

In order to understand the novelty and significance of the present invention, a brief review is presented here of a prior art MEMS VOA based on a shutter, fabricated in SOI by a DRIE process, as shown schematically in FIG. 1. In the figure there are shown two identical VOA units, both fabricated on the same SOI wafer 31, to form a two-channel (or part of a multi-channel) array. Referring to any one of them, a comb-drive actuator 20, manufactured with a shutter 26 on one side, is electrostatically actuated and moves in parallel to the wafer plane. A restoring mechanical force, provided by suspension springs (folded beams mechanism) 27, acts against the electrostatic force provided by the comb-drive 20 and the equilibrium point of the two forces determines the position of the shutter 26. The empty groove 30 is designed to secure two pre-cleaved optical fiber segments, (not shown in the figure), each segment on one side of the shutter 26.

In the prior art device shown in FIG. 1, all the silicon parts, including the shutter 26, are fabricated and are formed prior to the introduction of the two pre-cleaved optical fiber segments. A problem with this prior art construction is the introduction of deviations in the alignment of the cores, in the process of placing the two fibers in the groove 30 and securing them using either a gluing or clamping technique, for example, to secure the two different segments of fibers.

As described further herein, the present invention employs a construction technique which eliminates the alignment problem of the cores.

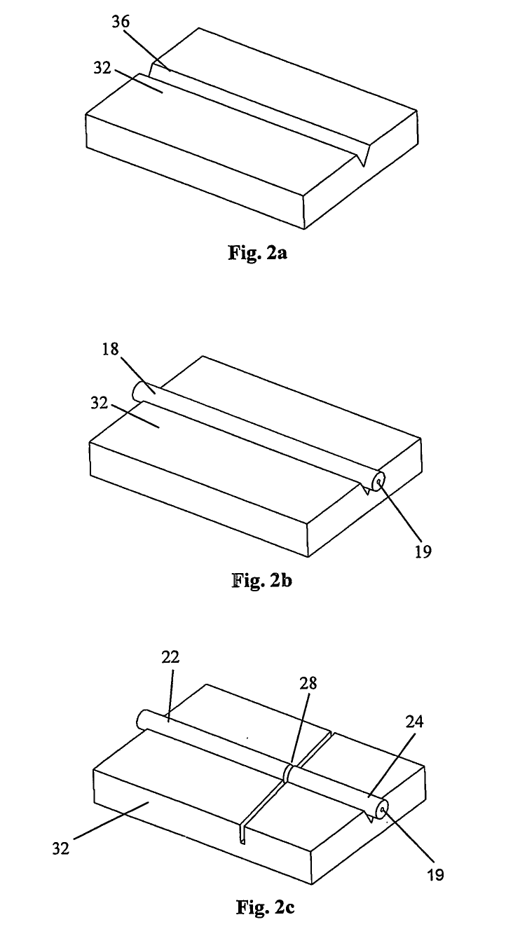

Referring now to FIGS. 2-5, illustrated are the construction stages of a device providing a variable optical attenuator mechanism employing a shutter, constructed in accordance with the principles of the present invention. This device is hereby referred to by the name “flipper”. The “flipper” is just one example of how to implement the innovations of the present invention. In addition, the present invention discloses a specific method used to treat the issue of optical coupling in a manner suitable for low cost manufacturing, by eliminating the need for time consuming and costly alignment of two optical fibers.

In contrast with the construction technique of the prior art described above, the manufacturing process according to the present invention starts with securing one section of an optical fiber on a substrate, then forming a gap through the fiber and only then integrating the shutter. Thus, the present invention achieves minimal insertion loss in a very economic manufacturing process. Another important difference is that the prior art device is DRIE manufactured on SOI wafer, while the present invention allows the use of ordinary crystalline silicon wafers and wet anisotropic etching for the micromachining process. As a result, cost of production is significantly reduced.

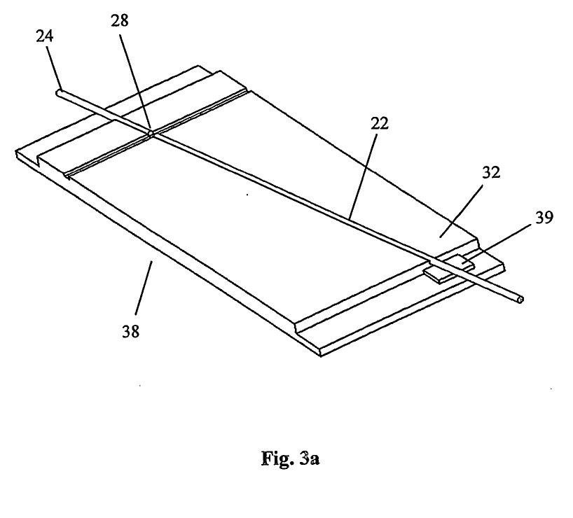

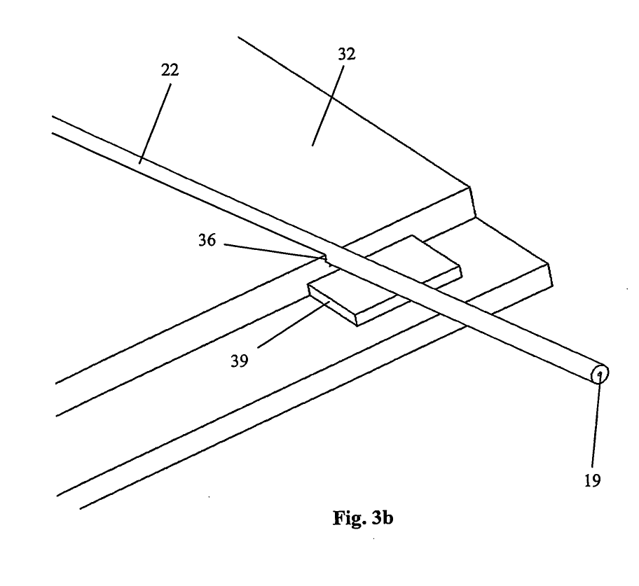

FIGS. 2a, 2b, 2c describe graphically the process of securing and cutting of the fiber 18, while FIGS. 3-5 illustrate schematically parts of the flipper VOA (one channel). The “flipper” device is formed on a substrate 32 configured for placement of a shutter 46 in the gap 28 between the two optical fiber segments 22, 24. In contrast to the prior art where, for each channel, two segments of fibers are placed in grooves after the shutter is fabricated, the fabrication sequence per the invention is different and is performed as described herein.

FIGS. 2a, and 2b, exhibit schematically a substrate with a groove (FIG. 2a), and a bare optical fiber 18 secured in the groove, showing the core 19 (FIG. 2b). The first step in the fabrication of the “flipper” device is to form the gap 28 in a fiber that is secured on the substrate 32 in a suitable V-shaped groove 36. The jacket of the fiber is stripped prior to securing in the groove. The gap is cut, at the preferred angle, through the secured optical fiber 18, using a preferred cutting method, like dicing, etching, laser cutting or any other suitable method. The cut should be deep enough so as to entirely cut the core. The substrate 32 should be thick enough so as not to be too much weakened by the cut.

Next, a micro-actuator, which includes a shutter, is inserted and positioned in the gap 28 in a manner that allows the shutter to be actuated and moved to its desirable position in the gap between the fiber edges. The gap 28 should be as narrow as possible in order to reduce insertion loss but because of the MEMS shutter dimensions, the gap width is a few tens of microns.

FIG. 2c illustrates the gap 28 which is formed in the secured fiber as described above.

According to the present invention, the two ends of the fiber cores, on both sides of the gap 28, match as completely as possible. This is because on both sides the cores are symmetrically and identically off-the-center, since they originate from the same fiber segment and are separated only by a distance of several tens of microns (the width of the gap created by the cut). Moreover, the deviations in alignment of the cores introduced by the securing process (i.e. gluing or clamping for example) of two different segments of fibers, as in the prior art, are also avoided since here the securing of the optical fiber 18 is performed prior to the cut. Thus, according to the present invention, the two segments 22, 24 formed by the cutting are automatically self-aligned. The described method and example are highly suitable for manufacturing and are low cost production-oriented.

The inventive method introduces cutting of a secured fiber, for example by dicing, as a solution for the alignment problem, and solves the misalignment introduced by mismatched non-concentric cores and prior art use of pre-cleaved fibers and alignment equipment to anchor the fibers. Since the gap formed by the cut is of the order of tens of microns and since the cut is made at an angle, index-matching fluid is used to obtain highly efficient optical coupling with low insertion loss as well as high return loss. A silicon shutter, etched on a flexible cantilever, is used to obstruct the beam by reflection or absorption.

The fabrication of a single channel “flipper” VOA device is described below as an example to the more general invention and innovative approach disclosed here.

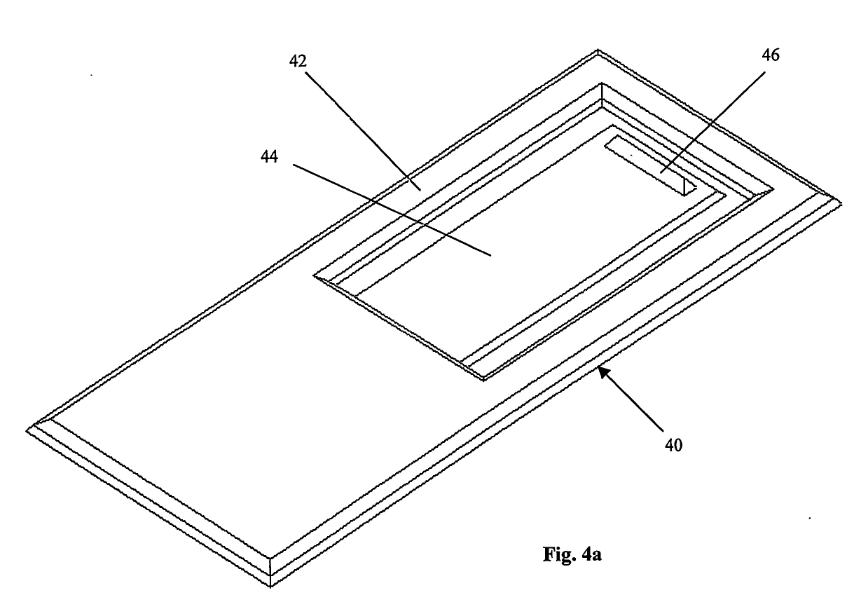

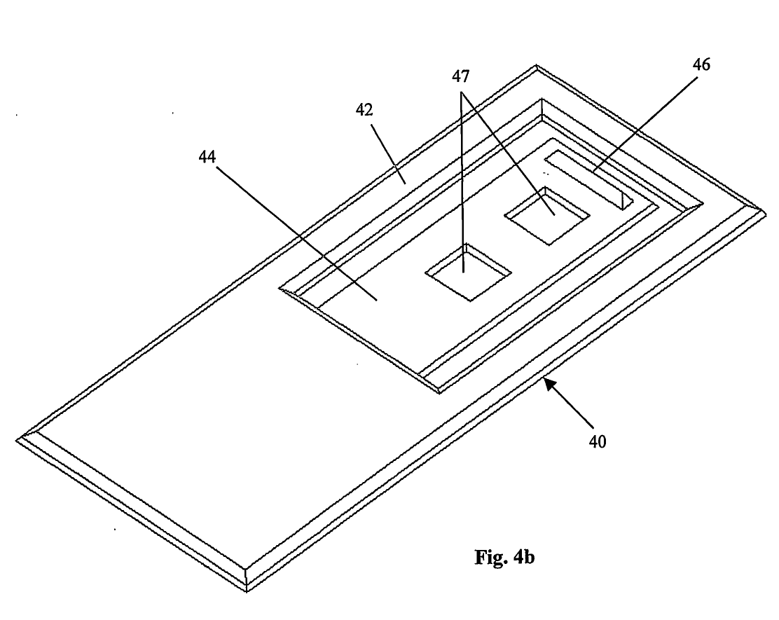

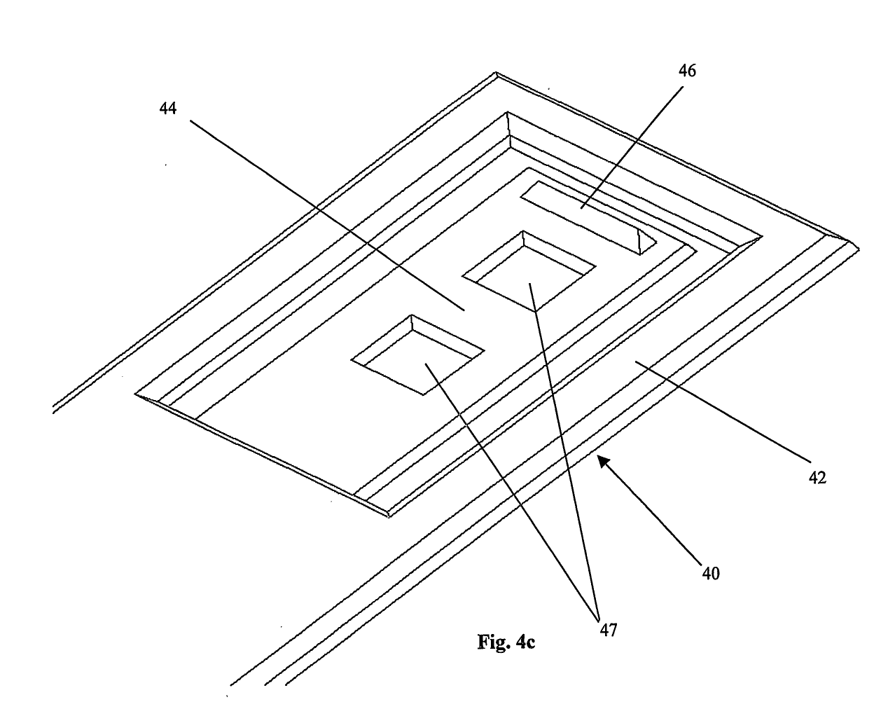

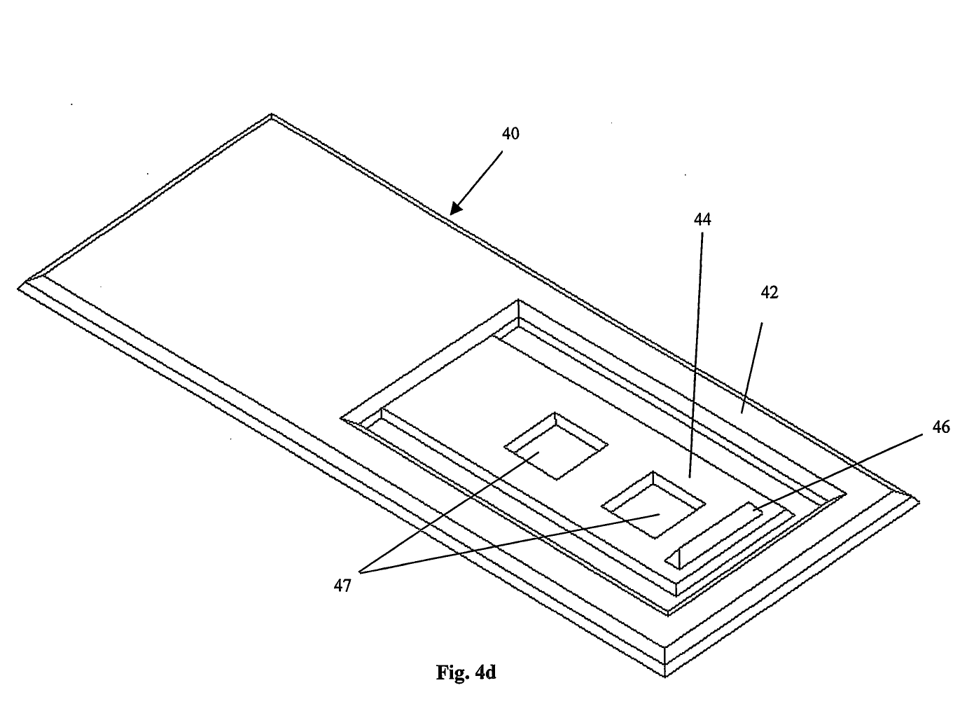

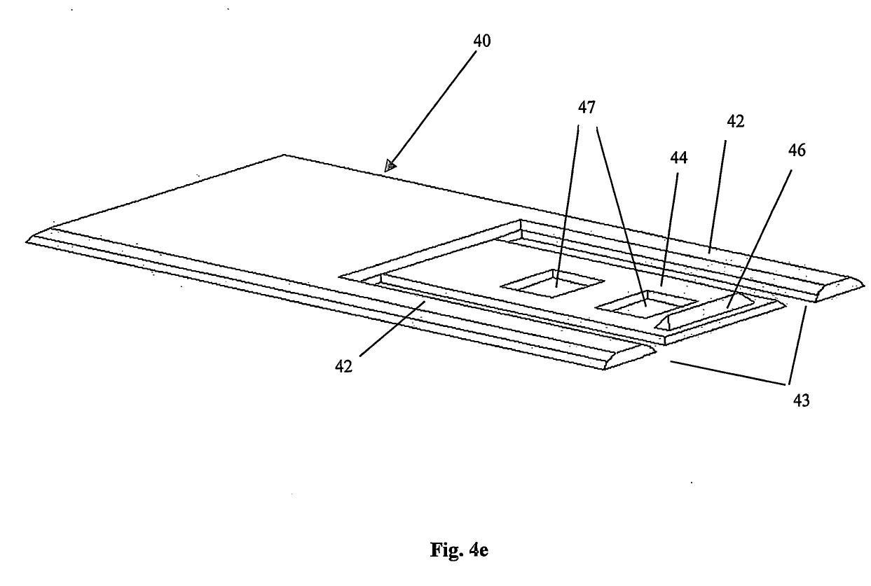

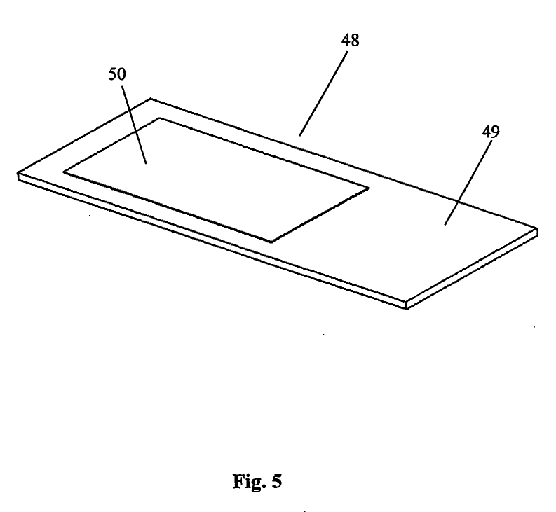

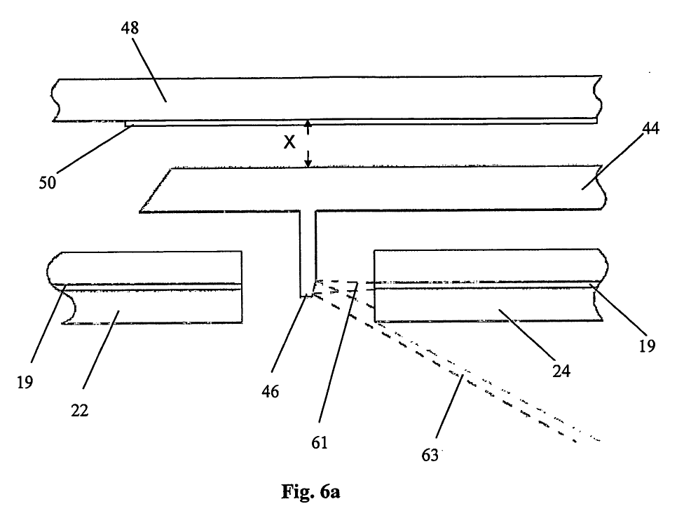

The “flipper” device for one channel VOA is manufactured by integrating three basic planar shaped units (see FIGS. 3a, 3b, 4a, 4b, 4c, 4d, 4e and 5, below):
(i) A base unit 38 (see FIG. 3a) that includes a silicon platform 32, which accommodates the input 24 and output 22 fibers, formed from one fiber segment that is cut to create the gap 28, in accordance with the method described with respect to FIGS. 2a, 2b, 2c; the base unit 38 may also house a photo-detector 39 (see FIGS. 3a, 3b) that is intended to monitor the optical power in the output fiber segment 22. The coupling between the photo-detector and the power-leaking zone of the fiber is accomplished by bringing the two in close contact (see FIG. 3b).
(ii) A “cantilever-shutter” unit 40 (see FIG. 4a, 4b, 4c, 4d, 4e), which is fabricated in silicon by wet etching, dry etching or any other technological procedure. This unit is composed of a frame 42, a flexible cantilever 44 which is fixed on one side to the frame and a shutter 46 shaped as a wedge. Holes 47 (see FIGS. 4b, 4c, 4d) may be manufactured in the flexible cantilever in order to allow improved temporal response during movement. The frame 42 may be designed with an opening 43 (see FIG. 4e), to allow easy filling with index matching fluid.
(iii) An electrode unit 48 (see FIG. 5), formed on a silicon substrate 49 which contains a thin (e.g. evaporated) metallic electrode 50 for electrostatic activation of the flexible cantilever 44.

The geometrical outer dimensions of the three units 38, 40 and 48 are similar, so that the three units can be integrated one on top of the other to form a three-layer structure, with the three units essentially overlapping.

The integration of a single channel “flipper” is a two-step process. In the first step, the cantilever-shutter unit 40 is attached on top of the base unit 38. The attachment is obtained by gluing, bonding, or by any other appropriate method of attachment. The attachment process needs to be such that the shutter 46 is introduced into the gap 28 while the parallelism and the required distance (usually several tens of microns) between unit 38 and unit 40 are maintained.

Next, in the second step, the electrode unit 48 is bonded (or attached by glue or any other suitable means) on top of the cantilever-shutter unit 40, again retaining the parallelism between the two units, and maintaining the appropriate distance (usually several tens of microns) between the cantilever-shutter unit 40 and the electrode unit 48. The means for retaining the appropriate distances between unit 40 and units 48 and 38 may be spacers of appropriate thickness. The spacers may be either separate parts or may be integral features of either of the units 38, 40, 48.

The means for ensuring appropriate positioning of the shutter 46, in the gap 28 between the fiber segments 22 and 24, may be standard assembly equipment, like a flip-chip bonder. Another possibility is to use alignment fudicials in the form of ridges, which are monolithically manufactured on the frame 42, and also to form matching cavities (or cuts or grooves), in the base unit 38.

The ridges and the matching cavities are then used to self align the two units (38 and 40) so as to ensure the appropriate positioning of the shutter 46 in the cut 28 between the fiber segments. The self-aligned positioning is accomplished by attaching units 38 and 40 when the ridges are seated in their matching cavities. Finally, electrical leads and wires (not shown in the figures) are bonded so that actuation voltage can be applied between the electrode 50 of unit 48 and the cantilever-shutter of unit 40.

The above “flipper” assembly procedure of the three units is performed vertically and therefore will be referred to by the term “vertical integration”. Similarly, vertical integration based on fudicials and matching cavities or grooves, as described above, for appropriate positioning of the shutter, will be referred to as “self-aligned vertical integration”.

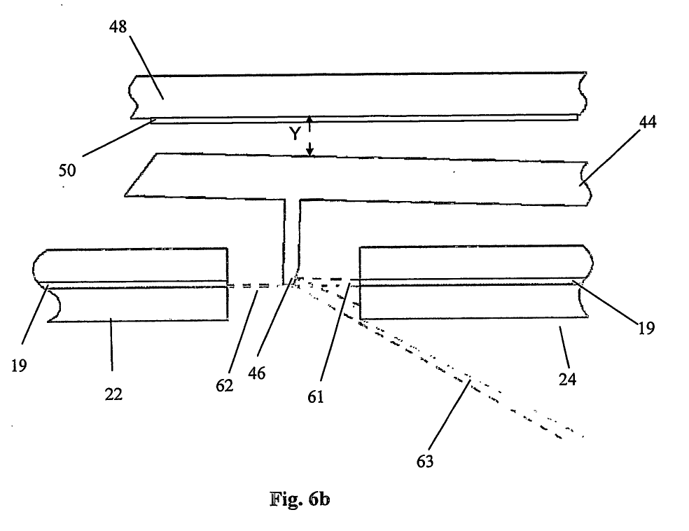

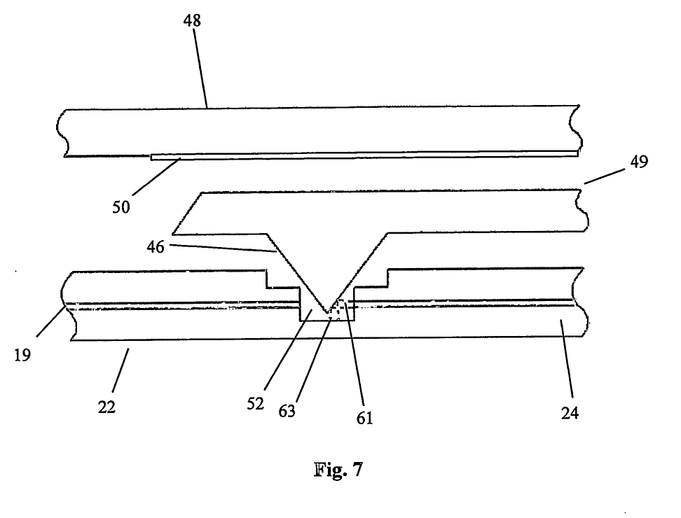

The assembly is operated such that without applying voltage between the flexible cantilever 44 and the electrode 50, the distance between them is X, (see FIG.6a), and the wedge of the shutter 46 blocks the entire free space path of the light between the input 24 and output 22 fiber segments, so that the light beam 61, emerging from the core of the input fiber 24, is totally absorbed or reflected 63 (FIG.6a).

When voltage is applied between the flexible cantilever 44 and the electrode 50 of electrode unit 48, the flexible cantilever 44 is attracted and bent towards the actuating electrode 50 of unit 48 (now separated by a smaller distance, Y, from the flexible cantilever) and the light beam is only partially blocked (see FIG. 6b) or not blocked at all, depending on the position of the shutter 46, so that part 62 of the beam 61 enters the core of the output fiber 22, while the other part is absorbed or reflected 63. The voltage level thus controls the optical power intensity.

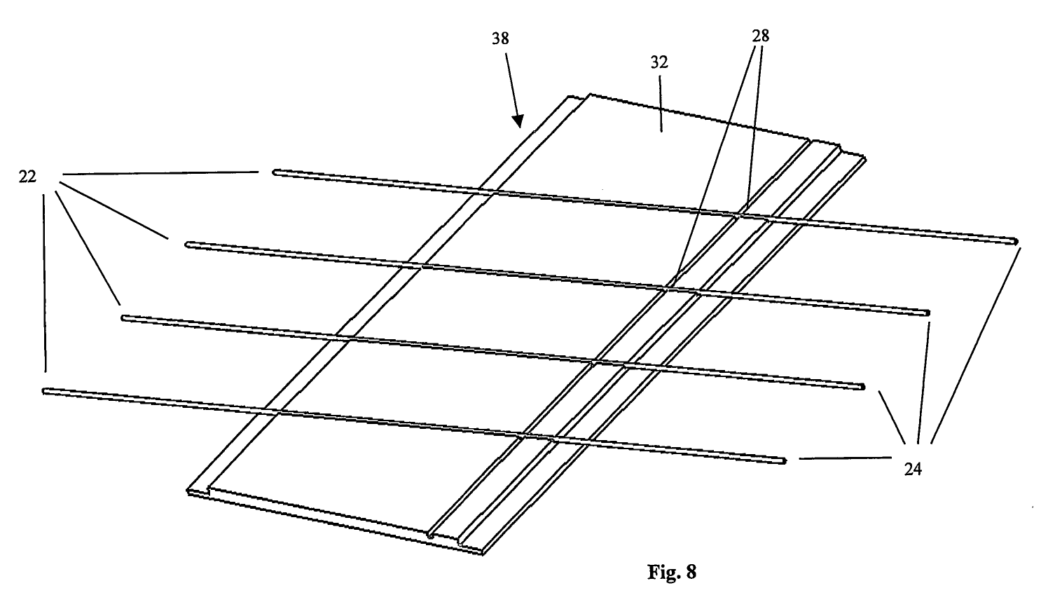

The present invention may be implemented using any geometrical form of a shutter as well as any suitable geometrical form of gap. For example, as shown in FIG. 7, a wedge-shaped shutter 46 and a featured gap 52 may be applied, with the gap 52 tailored to the geometry of the shutter 46 and designed to minimize the width of the free space path between the cores of the two fiber segments, in order to minimize insertion loss. Note that the gap in FIG. 7 runs through the core but not through the entire fiber cladding.

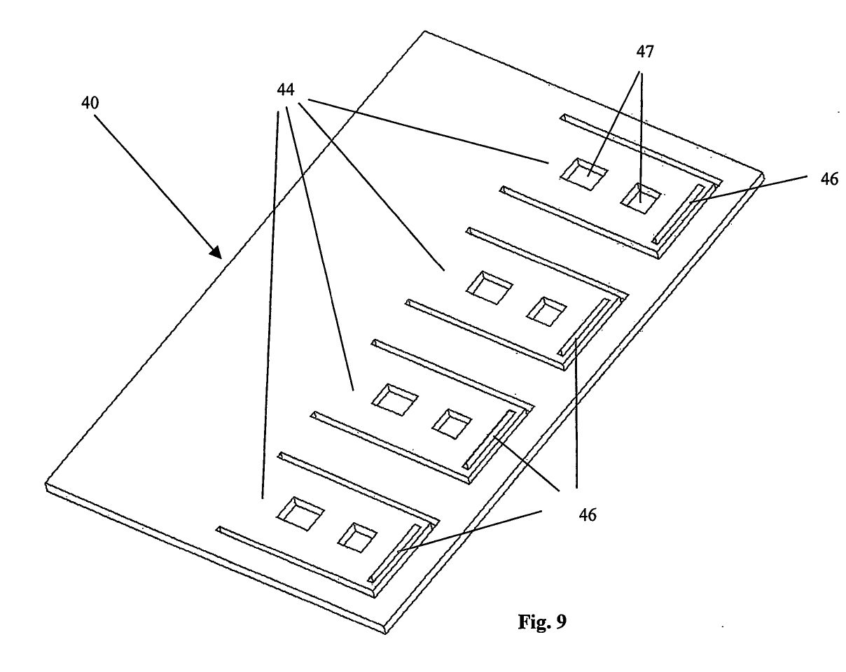

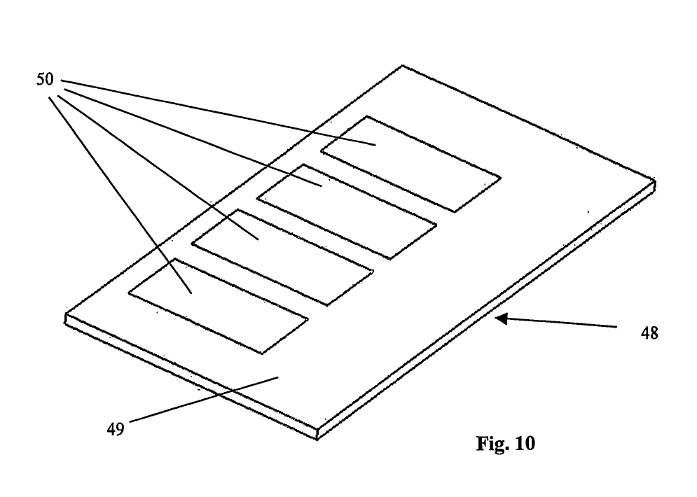

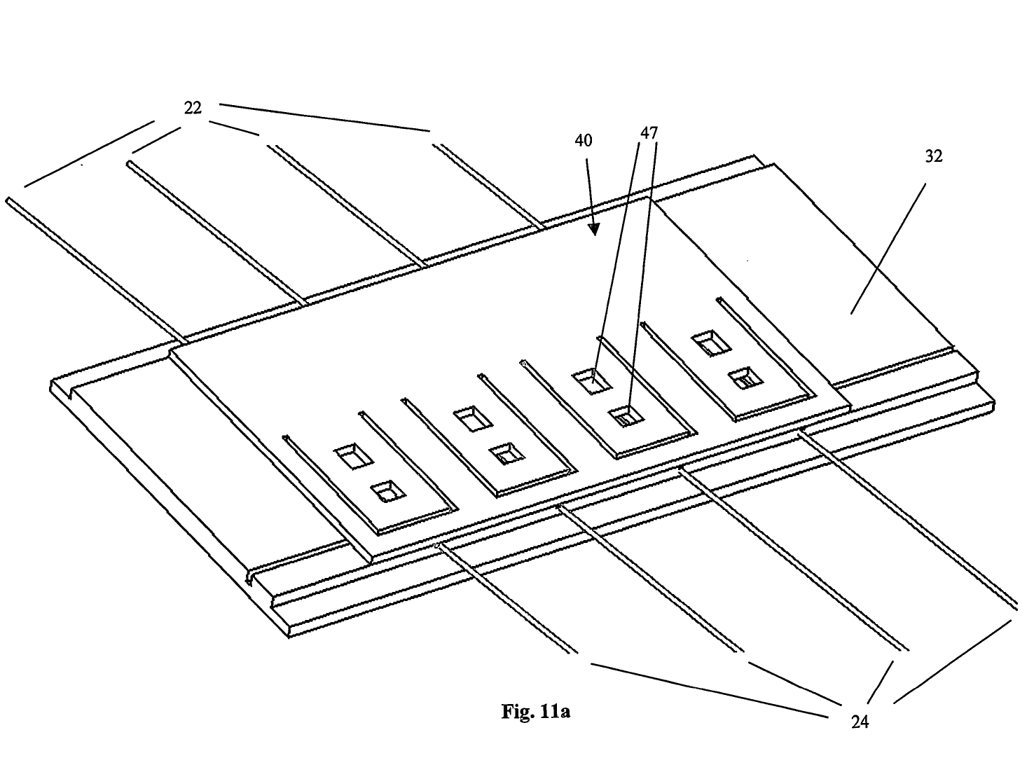

As shown in FIGS. 8, 9, 10, 11a and 11b, a similar construction procedure can be applied to obtain a multi-channel VOA, with an array of such VOAs as are described above. In this case, the base unit 38 (see FIG. 8) may contain several fibers, each of them fixed in its own groove and oriented in parallel. Correspondingly, the cantilever-shutter unit 40 (see FIG. 9) is fabricated with a number of flexible cantilevers 44 corresponding to the number of fibers, where each one has its own monolithic shutter 46 (see FIG. 9). Finally, the electrode unit 48 also contains several electrodes 50 corresponding to the number of shutters (see FIG. 10).

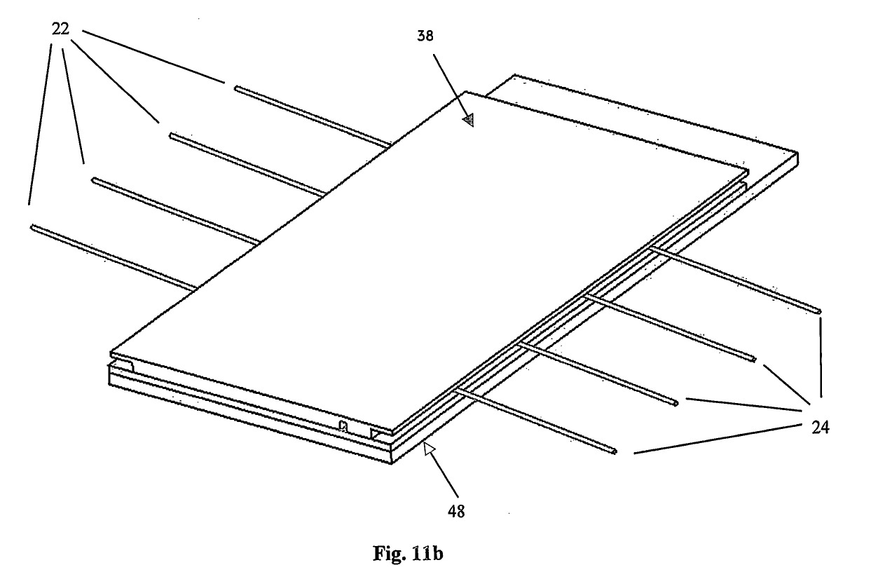

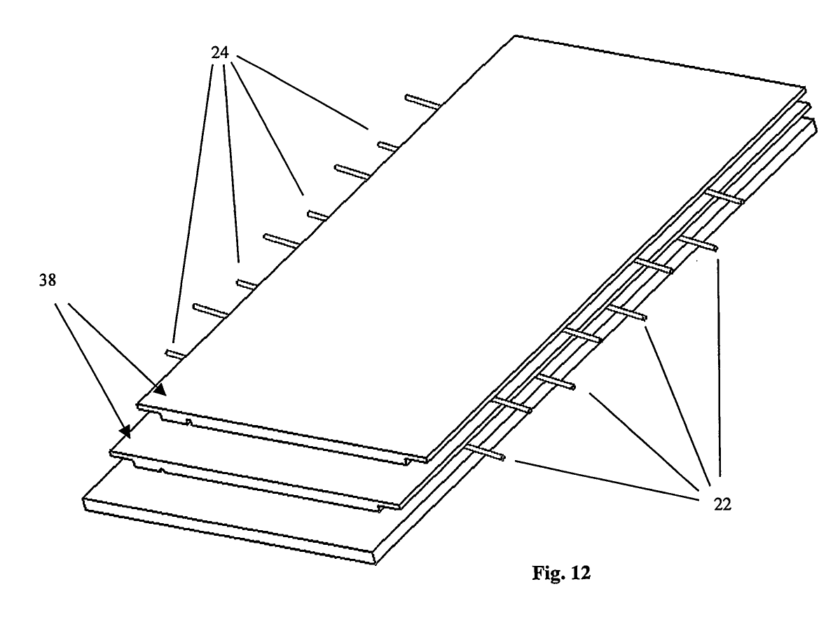

As shown in FIGS. 11a and 11b, the integration of the multi-channel VOA is performed in a vertical integration process similar to a single channel VOA. The number of bonding pads and wires (not shown in the figures) increases because each shutter 46 operates independently. Furthermore, a multilevel device, containing a larger number of channels, may be obtained by stacking several such levels (FIG. 12).

Integrated monitoring of the output power may be part of the VOA. Thus, the invented attenuator may or may not include integrated power monitoring. The monitoring may be achieved by several methods, as discussed above. The signal, from a photo-detector that reads the power, may be used to control the position of a shutter so as to obtain the desirable optical power at the output of the corresponding channel. In this case, each channel includes it own photo-detector and feedback loop, and operates independently.

Having described the invention with regard to certain specific embodiments and methods, it is to be understood that the description is not meant as a limitation, since further modifications may now suggest themselves to those skilled in the art, and it is intended to cover such modifications as fall within the scope of the appended claims.

1. A MEMS variable optical attenuator device, comprising:
a substrate having formed therein means for securing at least one optical waveguide;
at least one optical waveguide, each having a gap between segments thereof, wherein said. gap is formed once said at least one optical waveguide is secured by said securing means, thereby to insure optical alignment between said optical waveguide segments;
shutter means mounted proximate said gap formed in said at least one optical waveguide, said shutter means being movable inside said gap, in a dynamically variable amount as required, so as to block controllably a portion of the power of an optical signal propagating in said gap, between said optical waveguide segments; and
shutter actuation means to move said shutter means controllably and dynamically to any required position within said gap.

2. The device of claim 1, wherein said at least one optical waveguide is an optical fiber.

3. The device of claim. 1, wherein said at least one optical waveguide is a polarization maintaining optical waveguide.

4. The device of claim 1, wherein said at least one optical waveguide is a polarization maintaining optical fiber.

5. The device of claim 1, wherein said securing means comprises a groove formed in said substrate.

6. The device of claim 1, wherein said gap is formed so as to have featured cross-section and geometrical form, designed to accommodate a specific geometrical shape of said shutter means.

7. The device of claim 1, wherein said shutter means is capable of moving in a direction which is not parallel to the plane of said substrate, on which said at least one optical waveguide is secured.

8. The device of claim 1, wherein said shutter actuation means comprises a flexible cantilever on which said shutter means is mounted, said flexible cantilever being actuated by an associated electrostatic electrode, by applying voltage between said flexible cantilever and said electrostatic electrode.

9. The device of claim 1, wherein said shutter actuation means is operable by at least one force selected from the group of forces including electrostatic force, magnetic force, thermal expansion force, and pneumatic force.

10. The device of claim 8, wherein said flexible cantilever is fabricated with holes.

11. The device of claim 1, assembled by vertical integration.

12. The device of claim 1, assembled by self-aligned vertical integration.

13. The device of claim 1, further including integrated optical power monitoring means for control of the optical power in at least one of said segments of said at least one optical waveguide.

14. The device of claim 1, further including electronic means for providing automatic control of said shutter actuation means, for controllably and dynamically moving said shutter means to any required position within said gap.

15. The device of claim 1, further including index matching fluid, filling said gap formed in said at least one optical waveguide.

16. The device of claim 1 comprising a plurality of optical waveguides and a corresponding plurality of gaps, associated shutter means and associated shutter actuation means, wherein each of said plurality of shutter actuation means is operable independently.

17. A method for assembling a MEMS variable optical attenuator device, comprising the steps of:
providing a substrate having formed therein means for securing at least one optical waveguide;
providing at least one optical waveguide and securing it on said substrate;
forming a gap in said at least one optical waveguide once it is secured by said securing means, so as to form two optical waveguide segments, thereby insuring optical alignment between said optical waveguide segments;
mounting shutter means proximate said gap formed in said at least one optical waveguide, said shutter means being movable inside said gap, in a dynamically variable amount as required, so as to block controllably a portion of the power of an optical signal propagating in said gap, between said optical waveguide segments; and
providing shutter actuation means to move said shutter means controllably and dynamically to any required position within said gap.

18. The method of claim 17 wherein said gap forming step is performed by dicing.

19. The method of claim 17 wherein said gap forming step is performed by etching.

20. The method of claim 17 wherein said gap forming step is performed by laser cutting.

21. (canceled)

22. (canceled)
